(19) United States
(12) Patent Application Publication
(10) Pub. No.: US 2016/0094069 A1
(43) Pub. Date: Mar. 31, 2016

(54) BATTERY PACK AND FLASHLIGHT EQUIPPED WITH THE SAME

(71) Applicant: SANYO Energy (U.S.A) Corporation, Frisco, TX (US)

(72) Inventors: JunYoung PARK, Frisco, TX (US); Kazuyuki KAWAKAMI, Hyogo (JP); Shinichiro KITANO, Hyogo (JP)

(21) Appl. No.: 14/501,131

(22) Filed: Sep. 30, 2014

(51) Int. Cl. H02J 7/00; F21V 23/00; F21L 4/08

(52) U.S. Cl. CPC H02J 7/0042; H02J 7/0052; F21L 4/085; F21V 23/009; F21W 2111/10

(57) ABSTRACT

A battery pack comprises a cylindrical rechargeable battery, an electronic circuit board including a charging circuit to charge the battery, and being electrically connected to the battery, a cylindrical case incorporating the battery and the electric circuit board, and having openings at both ends thereof, and having a positive terminal and a negative terminal in the openings to discharge the battery, and having a hole in a recess portion at the peripheral surface thereof, and a connector port being disposed at the peripheral surface, and being fixed to the electrical circuit board, and an insertion opening of the connector ports being exposed through the hole at the peripheral surface of the case.

### TECHNICAL FIELD

The present invention is related to a battery pack, a flashlight equipped with the same.

### BACKGROUND ART

Regarding a battery pack having a cylindrical shape, the following structure is described in patent literature 1. The battery assembly as a battery pack comprises a rechargeable battery unit, a USB connector plug to be connectable to a USB port on a computing or peripheral device, recharging circuitry to control recharging of the rechargeable battery unit, and a cap. The battery assembly has a deployed configuration in which the cap covers the USB connector plug, and has the general form of and functions as a conventional battery format, and the conventional battery format is one of AAA, AA, C and D cylindrical battery types. The battery assembly having a recharge configuration in which the USB connector plug is made accessible by moving the cap to enable the USB connector plug to be connected to said USB port of a computing or peripheral device. Further the recharging circuitry is accommodated within the envelope of the connecting part of the USB connector plug.

### CITATION LIST

### Patent Literature

Patent Literature 1: U.S. Pat. No. 7,375,494

### SUMMARY OF THE INVENTION

In the above battery pack, when the battery pack discharge, a discharging current flows through the cap, and when the battery pack is charged, the battery pack is charged through the USB connector plug and the recharging circuitry by moving the cap. Therefore as the battery pack uses different terminals, namely the cap or the USB connector plug, the structure is complicated, so procedure of charging and discharging is not simple.

The present disclosure is developed for the purpose of solving such drawbacks. One non-limiting and explanatory embodiment provides a battery pack in which a structure is simple, and procedure of charging and discharging is also simple.

A battery pack of the present disclosure comprises a cylindrical rechargeable battery, an electronic circuit board including a charging circuit to charge the battery, and being electrically connected to the battery, a cylindrical case incorporating the battery and the electric circuit board, and having openings at both ends thereof, and having a positive terminal and a negative terminal in the openings to discharge the battery, and having a hole in a recess portion at the peripheral surface thereof, and a connector port being disposed at the peripheral surface, and being fixed to the electrical circuit board, and an insertion opening of the connector ports being exposed through the hole at the peripheral surface of the case. And the electrical circuit board is disposed perpendicularly to an axis of the cylindrical shape of the battery, and between one of the positive terminal and the negative terminal, and one end adjacent thereto of the battery.

A flashlight equipped with the battery pack of the present disclosure comprises a light portion, and, a cylindrical grip portion. And the cylindrical grip portion incorporates the battery pack.

### BRIEF DESCRIPTION OF DRAWINGS

FIG. 1 is a perspective view of a battery pack according to an embodiment of the present disclosure.

FIG. 2 is a perspective view from a different view point of the battery pack of FIG. 1.

FIG. 3 is views of the battery pack of FIG. 1, (a) is a plan view, (b) is a left side view, (c) is a right side view.

FIG. 4 is a vertical sectional view of the battery pack.

FIG. 5 is a block diagram showing a structure of the battery pack, (a) is a block diagram of a circuit board, (b) is a block diagram of the battery pack.

FIG. 6 is a perspective view of a flashlight as an electric device incorporating a battery pack of an embodiment.

### DESCRIPTION OF EMBODIMENTS

Embodiments of the present invention will be described below based on the drawings. Note, however, that the embodiments shown below exemplify battery packs and flashlight for embodying the technical idea of the present invention, and the present invention does not specify battery packs and flashlight to those shown below.

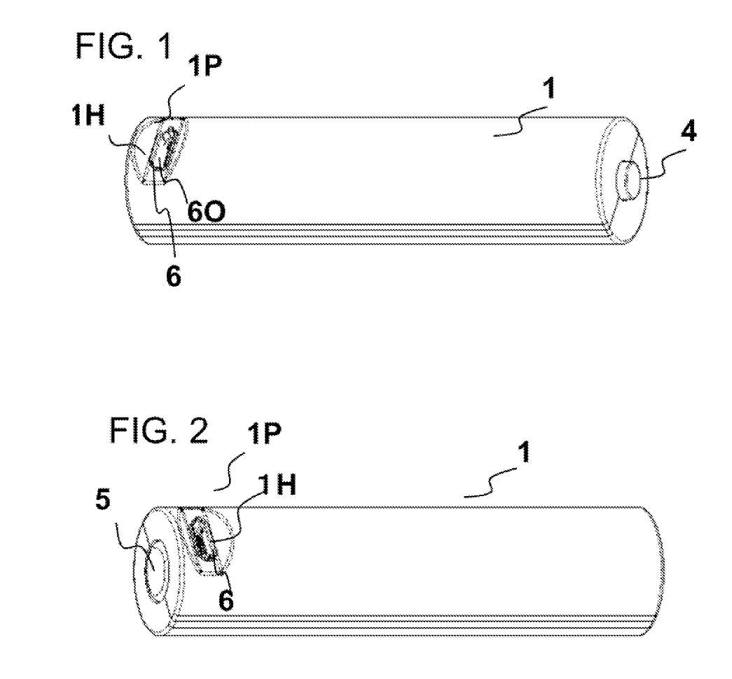

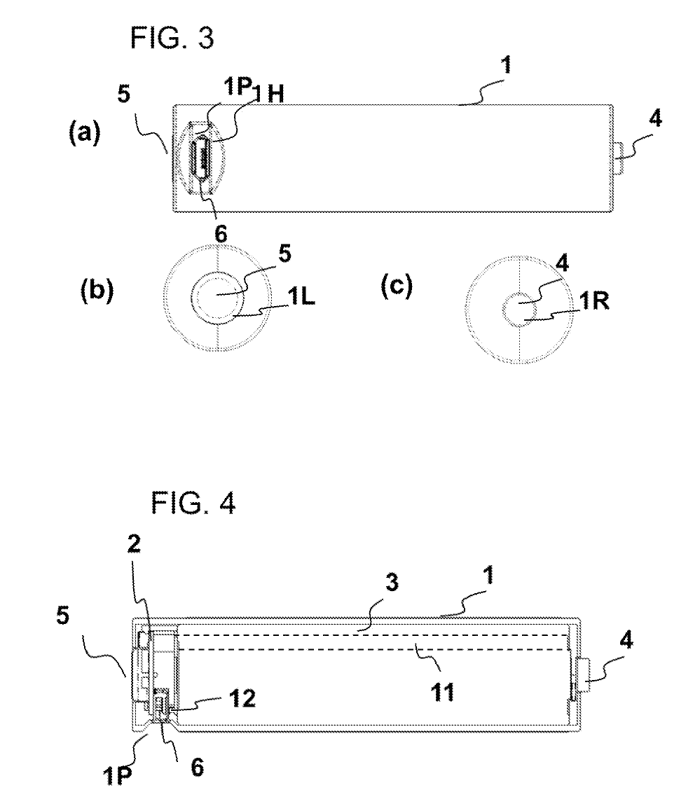

One embodiment of the battery pack of the present invention is shown in FIG. 1 to FIG. 5. In the battery pack, a cylindrical case 1 incorporates a cylindrical rechargeable battery 3 and an electronic circuit board 2 which includes a charging circuit to charge the battery 3. The battery 3 has a cylindrical shape, and both ends. In the battery, the right end is a positive pole having a projecting portion, and the left end and the peripheral surface are a negative pole. In addition in place of the above, the right end can be a negative pole, and the left end can be positive pole. The battery 3 is a lithium ion battery, and outputs approximately the voltage of 3.6-3.7 V. A nickel hydride battery or a nickel cadmium battery can also be used.

The cylindrical case 1 is made of resin having insulation property. The case 1 is divided into two parts of semicylindrical shape in the vertical direction. The case 1 has openings 1L, 1R at both ends thereof, and has a positive terminal 4 and a negative terminal 5 made of metal in the openings 1L, 1R to discharging, and has a hole 1H at the peripheral surface thereof. The hole 1H is located in a recess portion 1P at the peripheral surface thereof.

A connector port 6 is disposed at the peripheral surface, and is fixed to the electrical circuit board, and an insertion opening 60 of the connector ports 6 is exposed through the hole 1H at the peripheral surface of the case. In this embodiment, the connector port 6 is used for micro USB.

The positive terminal 4 is connected to the right end as the positive pole of the battery 3 via a diode 10. But the diode 10 is connected in its direction of allowing discharging and preventing charging through the positive terminal 4 and the negative terminal 5. The positive terminal 4 has a cylindrical shape which includes a bottom plate outside.

The electrical circuit board 2 is disposed perpendicularly to an axis of the cylindrical shape of the battery 3, and between the negative terminal 5 and the left end of the battery. The circuit board 2 is electronically connected to the battery 3 in the following. The circuit board 2 is connected to the right end (the positive pole) of the battery 3 by a lead plate 11. The lead plate 11 is a metal stripe board, and is insulated from the peripheral surface. And the circuit board 2 is connected to the left end (the negative pole) of the battery 3 by a lead board 12. The negative terminal 5 is disposed on an outer surface of the electric circuit board 2, and the connector port 6 is disposed on an inner surface of the electric circuit board 2. The negative terminal 5 has a cylindrical shape which includes a bottom plate outside.

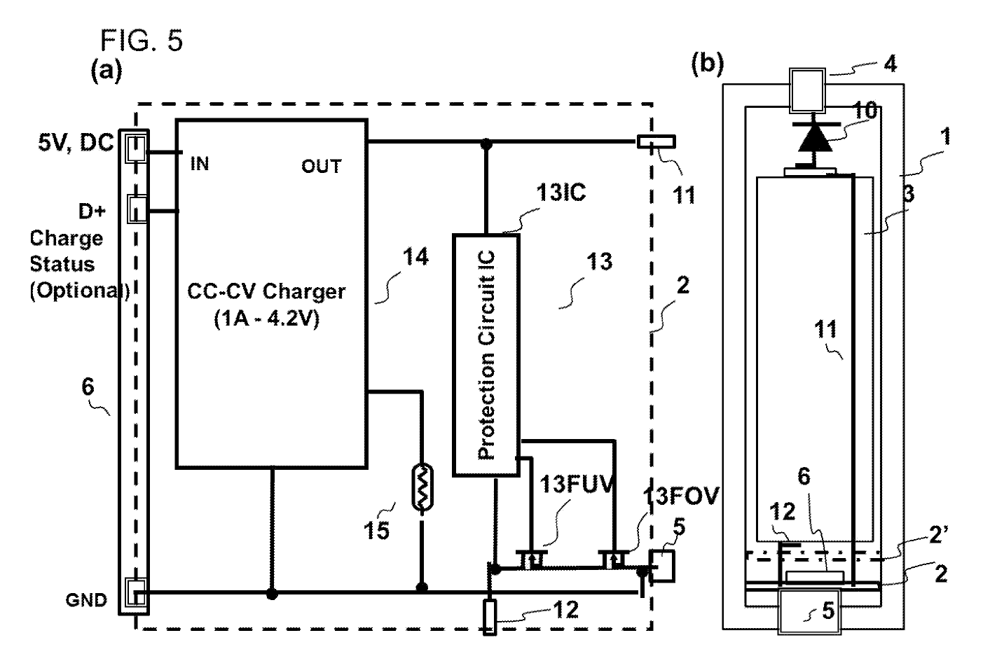

As shown in FIG. 5, the electronic circuit board 2 includes a protection circuit 13 to protect the over charge or the under discharge of the battery 3, and the charging circuit 14 to charge the battery. The charging circuit 14 as a IC receives the output (5V) of USB, outputs constant current—constant voltage charging to charge the battery 3. A temperature sensor 15 is thermally coupled to the battery 3, and monitors temperature of the battery 3. The voltage of the temperature sensor 15 is inputted to the charging circuit 14, and the charging circuit 14 controls charging based on the detected temperature. The protection circuit 13 comprises a protection circuit IC 13IC, a FET 13FOV, and a FET 13FUV. The protection circuit IC 13IC monitors voltage of the battery 3, and when the monitored voltage exceeds the predetermined over charge voltage, the protection circuit IC 13IC outputs the high voltage to the gate of the FET 13FOV, so by the FET 13FOV being turned off, charging current is cut off. And when the monitored voltage decreases less than the predetermined under discharge voltage, the protection circuit IC 13IC outputs the high voltage to the gate of the FET 13FUV, so by the FET 13FUV being turned off, discharging current is cut off. In the connector port 6, the positive (5V) terminal and the GND terminal are used in charging. In addition, by using D+ or D− terminal of the USB connector port 6, information of a charge status or the like from the charging circuit 14 or the circuit board 2 can be gained.

As the connector port 6 is disposed in the hole 1H in the recess portion 1P at the peripheral surface of the case 1, Though the USB cable (not shown in figures), the battery back is simply charged by the charging circuit 14. The positive terminal 4 and the negative terminal 5 are terminals for outputting discharging power. Charging through the positive terminal 4 and the negative terminal 5 is prevented by the diode 10 connected between the positive terminal 4 and the projecting portion of the battery 3.

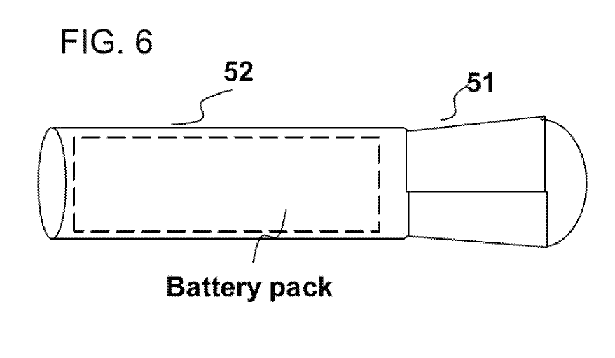

This cylindrical battery pack is used in an electric device, for example, a flashlight as shown in FIG. 6. Such a flashlight generally has a lighting portion 51 emitting light and a grip portion 52 griped by users. In the flashlight, the cylindrical grip portion incorporates a cylindrical battery. In this embodiment, as the battery pack is cylindrical, it is suitable for the flashlight incorporating the cylindrical battery and having the cylindrical grip. Especially as the connector port 6 does not project from the peripheral surface of the case 1, being located in the hole at the recess portion 1P, the battery packs of this embodiment is easily stored in the electric device, and easily discharge power. When the battery pack of this embodiment has the general shape and functions as a conventional battery format, it can have good versatility. The conventional battery shape is one of AAA, AA, C and D cylindrical battery types. In this case compatible with the general shape and functions as a conventional, output of the battery pack is controlled at 1.5 V by an outputting control circuit (not shown in figures).

The connector port 6 has an approximate box shape, and in an outer case of the connector port 6 its electrical potential is the ground potential, and the outer case of the connector port 6 is made of metal. Accordingly the heat generated in the circuit board 2 is efficiently radiated by the metal outer case of the connector port 6. As a long side of a rectangular shape of the insertion opening 6O of the connector port 6 in a front view in is fixed to the circuit board 2, short sides of the rectangular shape is parallel to the axis of the cylindrical shape of the battery, it can enable to make a length of the battery pack shorter. And also it can enable that the circuit board 2 including the connector port 6 is stored in a small space.

In this embodiment, a space is disposed between the inner surface of the electric circuit 2 board and the adjacent one end of the battery. Accordingly heat radiation from the circuit board 2 is good.

And the one of the positive terminal and the negative terminal, for example, the negative terminal in this embodiment is disposed on the outer surface of the electric circuit board 2, and the connector port 6 is disposed on the inner surface of the electric circuit board 2. Heat generated in the circuit board 2, for example, by the charging circuit 14 or the protection circuit 13, is radiated through the adjacent terminal or the connector port 6.

The electric circuit board 2 has a shape of a flat approximately circular plate which is approximately the same size as the bottom portion of the battery 3. As the cylindrical case 1 is the cylindrical shape, the circular circuit board 2 is easily fixed to the inside of the case 1, for example, by making a groove around an inner peripheral surface and setting the peripheral portion of the circuit board 2 into the groove (not shown in figures).

Furthermore another electric circuit board 2′ as shown by the dashed line in FIG. 5(b) can be set between the outer electric circuit board 2 and the bottom portion of the battery 3. In this case, the connector port 6 can be set on any one of the inner surface of the outer electric circuit board 2, the outer surface of the other electric circuit board 2′, or the inner surface of the other electric circuit board 2′. By using the circuit board 2 and the other circuit board 2′, the protection circuit 13, the charging circuit 14, and the connector port bare disposed in or on the large space of the circuit board.

1. A battery pack comprising:
a cylindrical rechargeable battery;
an electronic circuit board including a charging circuit to charge the battery, and being electrically connected to the battery;
a cylindrical case incorporating the battery and the electric circuit board, and having openings at both ends thereof, and having a positive terminal and a negative terminal in the openings to discharge the battery, and having a hole in a recess portion at the peripheral surface thereof; and
a connector port being disposed at the peripheral surface, and being fixed to the electrical circuit board, and an insertion opening of the connector ports being exposed through the hole at the peripheral surface of the case,
wherein the electrical circuit board is disposed perpendicularly to an axis of the cylindrical shape of the battery, and between one of the positive terminal and the negative terminal, and one end adjacent thereto of the battery.

2. The battery pack according to claim 1,
wherein the one of the positive terminal and the negative terminal is disposed on an outer surface of the electric circuit board, and the connector port is disposed on an inner surface of the electric circuit board.

3. The battery pack according to claim 1,
wherein a space is disposed between the inner surface of the electric circuit board and the adjacent one end of the battery.

4. The battery pack according to claim 1,
wherein the connector port has an approximate box shape, and a long side of a rectangular shape of the insertion opening of the metal connector port in a front view is fixed to the circuit board, short sides of the rectangular shape are parallel to the axis of the cylindrical shape of the battery.

5. The battery pack according to claim 1,
wherein the connector port is a micro USB port.

6. The battery pack according to claim 1,
wherein the electric circuit board has a shape of a flat circular plate.

7. The battery pack according to claim 1,
wherein the electric circuit board includes a protection circuit for the battery.

8. The battery pack according to claim 1,
wherein another electric circuit board is set between the outer electric circuit board and the bottom portion of the battery

9. A flashlight equipped with the battery pack according to claim 1,
the flashlight comprising:
a light portion; and
a cylindrical grip portion,
wherein the cylindrical grip portion incorporates the battery pack.
